(19) United States
(12) Patent Application Publication
(10) Pub. No.: US 2025/0209161 A1
(43) Pub. Date: Jun. 26, 2025

(54) SYSTEM AND METHOD FOR MAKING UNIQUE RECOMMENDATIONS BASED ON LOGS

(71) Applicant: PAYPAL, INC., San Jose, CA (US)

(72) Inventor: Sekar Krishnan, Nagercoil (IN)

(21) Appl. No.: 18/960,554

(22) Filed: Nov. 26, 2024

(30) Foreign Application Priority Data
Dec. 22, 2023 (IN) 202311087999

(51) Int. Cl. G06F 21/55; G06F 21/57; G06F 40/289

(52) U.S. Cl. CPC G06F 21/554; G06F 21/577; G06F 40/289

(57) ABSTRACT

A system may include a processor and a non-transitory computer readable medium having stored thereon instructions that are executable by the processor to cause the system to receive a conversation log between a first user and a second user, derive, via a first machine learning model, at least one text chunk from the conversation log, process, via a second machine learning model, the at least one text chunk, the second machine learning model trained using previous conversation logs to determine whether the at least one text chunk indicates a vulnerability, in response to the at least one text chunk indicating the vulnerability, classify a type of the indicated vulnerability, and automatically execute a remedial action based on the classified type.

### TECHNICAL FIELD

The instant disclosure relates to identifying that a participant in a conversation is vulnerable based on an artificial intelligence-aided review of a log of the conversation.

### BACKGROUND

Many online-based services offer the ability for users to chat with operators in order to address user problems. These chats are often relied upon by users to find answers to problems that are unique to the particular user (e.g., because the user was unable to find an answer in a pre-determined Frequently-Asked Questions section), or that may involve more sensitive subject matter for which the user requires more specialized support.

### BRIEF DESCRIPTION OF THE DRAWINGS

FIG. 1 is a block diagram of an example system for identifying a vulnerable participant in a conversation log.

FIG. 2 is a flow chart illustrating an example process of identifying a vulnerable participant in a conversation log.

FIG. 3 is a flow chart illustrating an example method of identifying a vulnerable participant in a conversation log.

FIG. 4 is a flow chart illustrating an example method of identifying a vulnerable participant in a conversation log.

FIG. 5 is a diagrammatic view of an example embodiment of a user computing environment.

### DETAILED DESCRIPTION

Online chat options provide an alternative to telephone-call options, and are an increasingly popular selection by users looking for support with a service. These online chats are more efficient for service providers, as support staff are able to participate in multiple chats at once (in contrast to telephone calls), and logs of the online chat provide a rich dataset that can be used to train support staff and to improve the customer experience. From the user perspective, the online chats may fit more conveniently within the users' schedules, as the online chats can be treated like text conversations and responded-to periodically. Online chats may also provide an opportunity for users to share sensitive information—such as a health condition or financial troubles—that a user may be uncomfortable verbally sharing but may feel comfortable sharing over chat due to the more abstract (e.g., removed from direct human contact) nature of texting rather than speaking.

Accordingly, due to the prevalence of online chats as well as the likelihood that users may share sensitive information in an online chat, there exists a need for a system that can identify users' vulnerabilities from chat conversations and automatically execute remedial actions to address the vulnerabilities. The term “vulnerability” may refer to a condition or status of a user that may prevent the user from fulfilling a previous obligation (e.g., user can no longer pay for a transaction) or that may keep the user from accessing full functionality of the service (e.g., user has a physical disability that prevents them from visiting a physical location of the service).

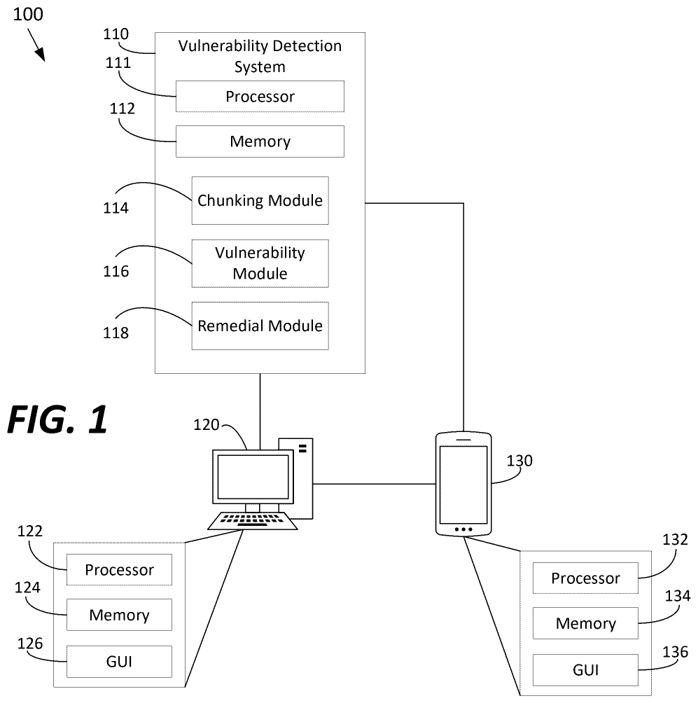

Referring to the drawings, wherein like reference numerals refer to the same or similar features in the various views, FIG. 1 is a block diagram of an example system 100 for processing a conversation log to identify and remediate a user vulnerability. As shown, the system 100 may include a vulnerability detection system 110, a service device 120, and a user device 130, each of which may be in electronic communication with one another and/or with other components via a network. The network may include any suitable connection (or combinations of connections) for transmitting data to and from each of the components of the system, and may include one or more communication protocols that dictate and control the exchange of data.

As shown, the vulnerability detection system 110 may include one or more functional modules embodied in hardware and/or software. In an embodiment, the functional modules of the vulnerability detection system 110 may be embodied in a processor 111 and a memory 112 (i.e., a non-transitory, computer-readable medium) storing instructions that, when executed by the processor 111, cause the vulnerability detection system 110 to perform the functionality of one or more of the functional modules and/or other functionality of this disclosure. For example, the vulnerability detection system 110 may process a conversation log to identify a vulnerability afflicting a participant in the conversation, and to automatically execute a remedial action to address the identified vulnerability.

The service device 120 may include a processor 122 and a memory 124, which may be any suitable processor and memory. In particular, the service device 120 may be a computing device (e.g., desktops, tablets, laptops, etc.). The memory 124 may store instructions that, when executed by the processor 122, cause a graphical user interface (GUI) 126 to display on the service device 120. This GUI 126 may be provided, in part, by the vulnerability detection system 110 and, particularly, one of the functional modules of the vulnerability detection system 110. The GUI 126 may enable the initial conversation, present analysis (by the vulnerability detection system 110) of a log of the conversation, and facilitate the remedial action.

Similarly, the user device 130 may include a processor 132 and a memory 134, which may be any suitable processor and memory. In particular, the user device 130 may be a mobile device (e.g., smartphones, tablets, laptops, etc.). The memory 134 may store instructions that, when executed by the processor 132, cause a graphical user interface (GUI) 136 to display on the user device 130. This GUI 136 may be provided, in part, by the vulnerability detection system 110 and, particularly, one of the functional modules of the vulnerability detection system 110. The GUI 136 may facilitate a conversation with the service device and implement the remedial action determined by the vulnerability detection system 110.

The functional modules may include a chunking module 114 configured to receive a log of a conversation and to process the log to derive one or more text chunks. The conversation log may be a transcript, listing, or description of a chat between two (or more) users. In some embodiments, the chat may be between a user of a service (e.g., financial institution) and a service agent (e.g., an employee of the service), such that the conversation log details a support chat between the user and service agent.

The chunking module 114 may receive the conversation log as an unstructured text file, and may process the log to reconstruct (e.g., add structure to) the log. For example, the chunking module 114 may include a natural language model (NLM) pre-trained to derive conversational-style text chunks from the unstructured text file. The chunking module 114 may utilize the NLM to determine particular words or parts of speech that may indicate a sentence or statement within the unstructured text file. Based on the analysis from the NLM, the chunking module 114 may divide the text file into one or more text chunks. The chunking module 114 may determine a text chunk as a portion of the text file that includes a pre-defined number or list of parts of speech (e.g., one noun and one verb), or as a portion of the text file bounded by punctuation (e.g., a parenthetical phrase)—or based on a combination of parts of speech with punctuation. In some embodiments, the chunking module 114 may determine text chunks as complete sentences. In some embodiments, the chunking module 114 may determine text chunks as incomplete—or partial—sentences.

Prior to dividing the file into chunks, the chunking module 114 may process (e.g., pre-process) the text file to remove noise from the text. This noise may include white spaces (e.g., more than one or two spaces between words), contractions (e.g., can't, won't, etc.), special characters (e.g., $, %, #, etc.), and accented words (e.g., jalapeño). For white spaces, the chunking module 114 may remove the additional spaces. For contractions, the chunking module 114 may replace the contraction with the two or more words shortened and represented by the contraction. For special characters, the chunking module 114 may replace the character with an appropriate word of phrase represented by the character (e.g., “money” for $, “at” for @, etc.). For the accented words, the chunking module 114 may replace any accented character in the word with an unaccented character.

In some embodiments, the chunking module 114 may receive the conversation log as an audio file, such that the conversation log is indicative of a phone call than of an online chat. In these embodiments, the chunking module 114 may first process the conversation log with an audio-to-text convertor, such as with an automatic speech recognition (ASR) program. Once the chunking module 114 converts the conversation log to a text file, the chunking module may further process the text file as described above.

The functional modules may include a vulnerability module 116 configured to receive the text chunks from the chunking module 114 and to determine that one or more of the text chunks indicate a vulnerability experienced by the user in the conversation. The vulnerability module 116 may generate an embeddings vector for each of the received text chunks using a machine learning model trained using a dataset that includes text portions with manually-assigned vulnerability determinations. The embeddings vectors generated by this trained model, then, may represent—in a vector plot—an extent to which the associated text chunk indicates a vulnerability.

The vulnerability module 116 may determine that one or more text chunks indicate a vulnerability (e.g., are relevant) based on a distance between a vector associated with each text chunk and a reference vector. In some embodiments, the reference vector may be established by the vulnerability module 116 without reference to a text chunk, such that the reference vector does not represent text but instead plots a position that the vulnerability module 116 (e.g., the trained machine learning model of the vulnerability module 116) would associate with a fully-indicated (e.g., with near 100% confidence) vulnerability. In some embodiments, the vulnerability module 116 may receive a pre-determined text portion, chunk, or phrase that is indicated as a reference text chunk. In these embodiments, the reference vector may be established by the vulnerability module 116 as an embeddings vector—generated by the trained machine learning model—representative of the reference text chunk.

Once the vulnerability module 116 has determined a distance between each embeddings vector and the reference vector, the vulnerability module 116 may assign a vulnerability score to each text chunk based on the distance. The vulnerability score may be indicative of a probability that the associated text chunk indicates a vulnerability. In some embodiments, the vulnerability score may be a standardized value that accounts for a distribution of distances across the entire generated set of embeddings vectors. In these embodiments, the closest embeddings vector (e.g., the shortest distance) may be assigned a vulnerability score of ‘1’ (e.g., a 100% probability that the associated text chunk indicates a vulnerability), and the farthest embeddings vector (e.g., the longest distance) may be assigned a vulnerability score of ‘0’ (e.g., a 0% probability that the associated text chunk indicates a vulnerability). In some embodiments, the vulnerability module 116 may use a separately-trained machine learning model (e.g., a Random Forest model, XGB model, Neural Networks, etc.) in order to determine similarity based on the generated vectors.

The vulnerability module 116 may then compare each vulnerability score to a threshold value. The threshold value may be dynamically set by the vulnerability module 116 in response to a desired sensitivity for the vulnerability detection system 110. For example, a lower threshold value would lead to an increased number of text chunks being identified as relevant, such that the vulnerability module 116 may set a lower threshold value in order to proactively identify an increased number of vulnerable users. Alternatively, a higher threshold value would lead to a decreased number of text chunks being identified as relevant, such that the vulnerability module 116 may set a higher threshold value in order to conservatively identify a decreased number of vulnerable users. In some embodiments, the vulnerability module 116 may omit the generation of a vulnerability score, such that the threshold comparison is between the calculated distance and a threshold value. In these embodiments, the vulnerability module 116 may reverse the comparison, such that those text chunks having corresponding distances less than the threshold are determined as relevant, with text chunks having corresponding distances greater than the threshold being determined as irrelevant.

In some embodiments, the vulnerability module 116 may be further configured to classify a type of vulnerability indicated by each of the relevant text chunks. This classification may be referred to as the “vulnerability state”—namely, the type of category of condition that qualifies the user as vulnerable. The vulnerability state may be selected from a list defined by the Financial Conduct Authority (FCA), which may include low capability (e.g., lacking funds to complete transaction), low resilience (e.g., operating with low margins and at risk of being disrupted by an unexpected event), negative life event (e.g., in the midst of short-term circumstances that materially affect a user), or ongoing health condition (e.g., long-term circumstances that materially affect a user). In some embodiments, the vulnerability module 116 may classify the vulnerability state based on an analysis of each relevant text chunk using a natural language processing (NLP) model to identify terms associated with each type of vulnerability, such as “doctor” for ongoing health condition, or “lost my job” for negative life event.

In some embodiments, the vulnerability module 116 may classify the type of vulnerability using reference embeddings vectors for each type of vulnerability. In these embodiments, the vulnerability module 116 may compare the determined vectors to multiple reference vectors that correspond to the possible vulnerability types. As with the single reference vector described above, the multiple reference vectors here may be generated to represent reference phrases or text portions for each type of vulnerability, or may exist in the vector-field without a corresponding phrase. In these embodiments, the vulnerability module 116 may compare a vector representative of a relevant text chunk to each of the reference vectors, and may classify the relevant text chunk as a vulnerability state corresponding to the closest reference vector.

As part of determining a vulnerability state for the conversation log, the vulnerability module 116 may assign a confidence score to the determination. In some embodiments, the confidence score may be the vulnerability score determined above, as the vulnerability score may be indicative of a probability that the text chunk from the conversation log indicates a vulnerability. Given that the confidence score may also indicate a probability that the vulnerability module 116 is correct in its determination, it is clear that the two scores may be equally represented by a single value. In some embodiments, the confidence score may be determined based on a confidence value of the trained machine learning model, which indicates an extent to which the machine learning model interprets its accuracy.

The functional modules may include a remedial module 118 configured to determine an appropriate remedial action based on the classified vulnerability state, and to automatically execute the appropriate remedial action. Generally, the available remedial actions fit into four categories: assistance (e.g., step-by-step instruction for registering a new line of credit), asset transfer (e.g., processing a refund, extending a loan), teaching (e.g., document outlining benefits and downsides of different types of retirement accounts), or empathy (e.g., a kind note). The remedial module 118 may determine the appropriate remedial action entirely based on the classified vulnerability state. For example, the remedial module 118 may determine that the appropriate remedial action is an asset transfer in response to the classified type being low capability.

In some embodiments, the remedial module 118 may retrieve data regarding the user associated with the conversation log at-issue in order to inform the determination of the appropriate remedial action. This retrieved data may include a status of the user's account, a history of the user's interactions with the service provided by the service device 120, and any prior remedial action taken for the user by the vulnerability detection system 110. For example, if the user received an empathy-style remedial action recently (e.g., within a prior week), the remedial module 118 may determine the appropriate remedial action as an action more likely to be impactful, such as an asset transfer. In another example, in response to the user's account status indicating that the user's financial accounts are outside of a worrisome range (e.g., above an average value over the last year), the remedial module 118 may determine the appropriate remedial action as an empathy-style remedial action as the user's financial accounts may indicate that the user's vulnerability is perceived (rather than actual).

In some embodiments, the remedial module 118 may determine a remedial action by deriving a request from the relevant text chunk and determining whether the requested action would address the determined vulnerability. Similar to how the remedial module 118 classifies the vulnerability from the relevant text chunk, the remedial module 118 may employ a NLP model to identify terms associated with each of the possible remedial actions. Based on the identification of terms, the remedial module 118 may determine whether the relevant text chunk includes a “vulnerability action”—namely, a request for action motivated (or clarified) by the identified vulnerability state.

In some embodiments, the remedial module 118 may determine (or extract) the vulnerability action from a text chunk in a similar manner to how the vulnerability module 116 may determine the vulnerability state—by comparing an embeddings vector representative of the relevant text chunk to a set of reference vectors that correspond to each of the possible vulnerability actions. The remedial module 118 may then determine the vulnerability action contained within the text chunk as the vulnerability action represented by the reference vector closest to the determined embeddings vector.

As part of determining a vulnerability action for the conversation log, the remedial module 118 may assign a confidence score to the determination. In some embodiments, the confidence score may be determined based on a confidence value of the trained machine learning model utilized to generate the embeddings vectors and reference vectors. The confidence value of the trained machine learning model indicates an extent to which the machine learning model interprets (or represents) its own accuracy.

Once the remedial module 118 has determined the appropriate remedial action, the remedial module 118 may automatically and autonomously execute the appropriate remedial action. For example, if the appropriate remedial action is an empathy-style action, the remedial module 118 may use a generative artificial intelligence (AI) model to generate a note to the vulnerable user that incorporates content from the relevant text chunk (or from the entire conversation log from which the relevant text chunk is extracted). In another example, if the appropriate remedial action is a short-term loan, the remedial module 118 may determine a loan whose terms would satisfy the vulnerability state. In those situations in which the remedial action is an asset transfer (e.g., a loan), the remedial module 118 may further retrieve data regarding the user's account with the service in order to evaluate if the user would qualify for the asset transfer (e.g., is the user credit-worthy for the proposed loan, etc.)

In some embodiments, the remedial module 118 may automatically execute the remedial action based on the confidence scores determined by the vulnerability module 116 and the remedial module 118 for the vulnerability state and vulnerability action respectively. Because the confidence scores may be indicative of the probability that the respective modules are “correct” (e.g., the determined vulnerability matches the actual vulnerability), the remedial module 118 may execute the remedial action in response to both modules being probably correct.

In some embodiments, the remedial module 118 may generate a notification for the service device 120 that indicates the text chunks from the conversation log that includes the vulnerability state and/or action, as well as the remedial action recommended as appropriate for the vulnerability. In these embodiments, the service device 120 may then execute the recommended remedial action.

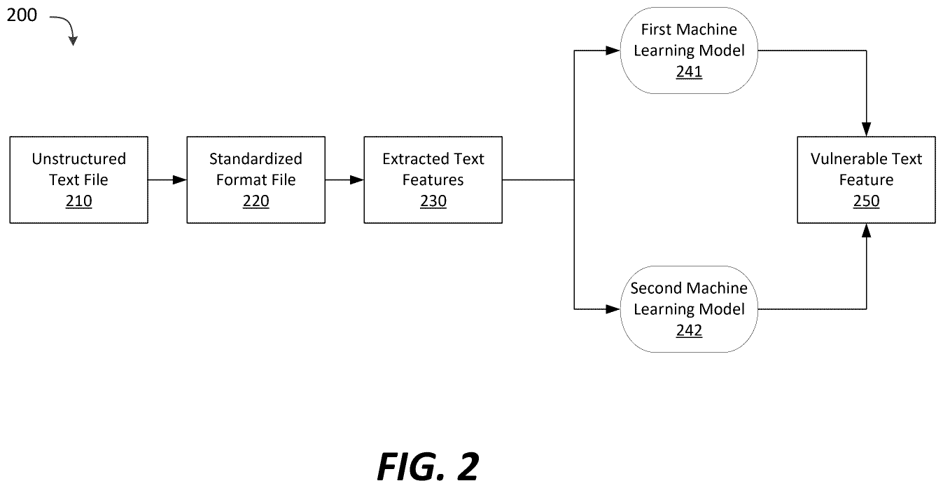

FIG. 2 is a process chart illustrating an example process 200 of identifying a vulnerable participant in a conversation log. The process 200, or one or more portions of the process 200, may be performed by the vulnerability detection system 110 (shown in FIG. 1) and, in particular, the chunking module 114 (for initially processing the received log) or vulnerability module 116 (for analyzing the processed log), in some embodiments. Each rectangular box in the process 200 chart may represent an asset, and each rounded box in the process 200 chart may represent a model that receives an asset as an input and outputs another asset.

The process 200 may begin with an unstructured text file 210. The unstructured text file 210 may be representative of a conversation log between two parties (e.g., a user and a support agent), and may be received from a storage location associated with one of the two parties (e.g., memory 124 of the service device 120). The text file 210 may be unstructured based on a format of the text file 210, such the data contained within the text file 210 lacks structure and/or organization. For example, the unstructured text file 210 may be formatted to be read by a word processing program, such that the unstructured text file 210 may include metadata or other internal data markers unique to the word processing program and irrelevant to the analysis performed by the vulnerability detection system 110. In other examples, the unstructured text file 210 may be a PDF file, an image file (e.g., ‘.jpeg’), or a spreadsheet file (e.g., ‘.xml,’ ‘.json,’ ‘.csv,’ etc.)

The process 200 may continue with generating a standardized-format file 220 based on the unstructured text file 210. To generate the standardized-format file 220, the vulnerability detection system 110 may extract text from the text file 210 (e.g., removing unrelated metadata or formatting parameters), and may add structure by organizing the text to follow the represented conversation. For example, the standardized-format file 220 may include line breaks to separate the portions of the conversation attributable to the different parties.

The process 200 may continue with extracting text features 230 from the standardized-format file 220. As described above with reference to the chunking module 114, the vulnerability detection system 110 may extract text features 230 using, in some embodiments, an NLM pre-trained to derive conversational-style text chunks from the unstructured text file, which may be indicated based on parts of speech within each chunk.

The process 200 may continue with each of a first machine learning model 241 and a second machine learning model 242 receiving, as input, the extracted text features 230. The first machine learning model 241 and the second machine learning model 242 may be separately trained to determine an expected status of a vulnerability indicated by a text feature 230 and an expected remedial action for the indicated vulnerability. Each model may output a confidence value for their determinations, with a higher confidence value indicative of higher probability of vulnerability in the text feature 230.

The process 200 may then determine a vulnerable text feature 250 (or at least one vulnerable text feature) from the extracted text features 230 based on the output of one or both of the first and second machine learning models 241, 242. In one example, the output of the first machine learning model 241 may be a probability that the associated text feature indicates a vulnerability state, and the output of the second machine learning model 242 may be a probability that the associated text feature indicates a vulnerability action. In this example, the vulnerability detection system 110 may determine the vulnerable text feature 250 as a text feature having both determined probabilities that exceed a threshold.

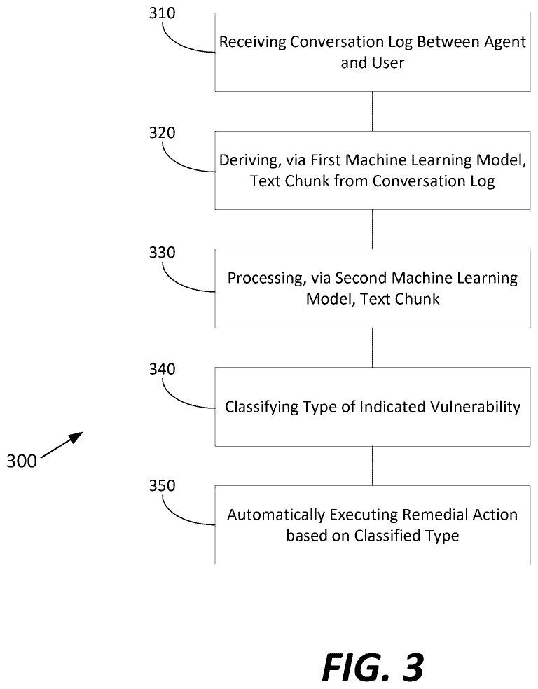

FIG. 3 is a flow chart illustrating an example method 300 of identifying a vulnerable participant in a conversation log. The method 300, or one or more portions of the method 300, may be performed by the vulnerability detection system 110 (shown in FIG. 1) and, in particular, one or more of the functional modules.

The method 300 may include, at block 310, receiving a conversation log between a service agent (e.g., a first user) and a service user (e.g., a second user). The conversation log may be received from a data storage system for the service hosting an initial conversation reflected in the log, such as the service device 120. The conversation log may be a raw text file that includes a transcript of the conversation (either directly from a chat service or via a speech-to-text service) as unformatted text, or may be formatted to comply with one or more standard file formats (e.g., ‘.pdf,’ ‘.jpeg,’ ‘.doc,’ etc.).

The method 300 may include, at block 320, deriving at least one text chunk from the conversation log via a first machine learning model. As described above with reference to the chunking module 114, the first machine learning model here may be a NLP model that identifies one or more parts of speech in the conversation log. Based on the identified parts of speech, the vulnerability detection system 110 may then divide the conversation log.

The method 300 may include, at block 330, processing the at least one text chunk via a second machine learning model. As described above with reference to the vulnerability module 116, the second machine learning model here may be an embeddings generator that generates embeddings vectors that represent the derived text chunks. The embeddings generator may be trained using past conversation logs previously identified as indicating (or not indicating) a vulnerability, such that the embeddings generated by this second machine learning model represent an extent to which the associated text chunk indicates a vulnerability.

The method 300 may include, at block 340, classifying a type of vulnerability indicated by the text chunk. As described above with reference to the vulnerability module 116 and the remedial module 118, embeddings vectors may be generated for each of a set of reference text chunks, which may be text chunks pre-determined as paragons (e.g., most on-point examples) of particular vulnerability types.

The method 300 may include, at block 350, automatically executing a remedial action based on the classified type. As discussed above with reference to the remedial module 118, the vulnerability detection system 110 may determine an appropriate remedial action as one or more remedial actions associated (e.g., in memory 112) with the classified type. For example, if the appropriate remedial action is a short-term loan, automatically executing the remedial action may mean that terms for a short-term loan are presented to the user device 130.

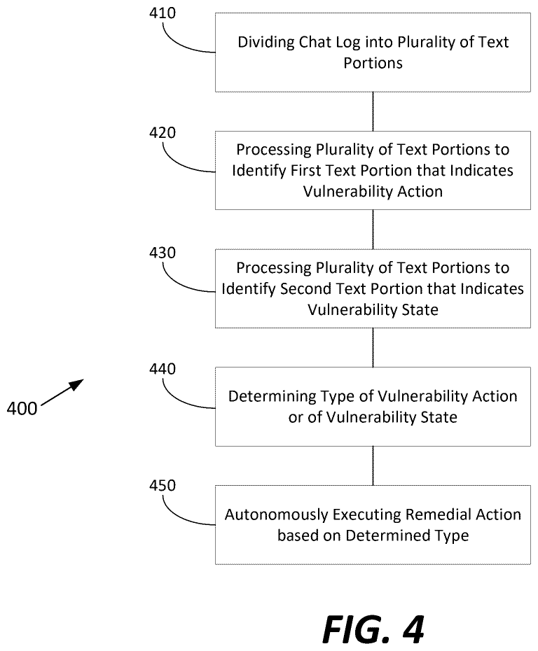

FIG. 4 is a flow chart illustrating an example method 400 of identifying a vulnerable participant in a conversation log. The method 400, or one or more portions of the method 400, may be performed by the vulnerability detection system 110 (shown in FIG. 1) and, in particular, one or more of the functional modules.

The method 400 may include, at block 410, dividing a chat log into a plurality of text portions. These text portions may be the text chunks referred to above with regard to the chunking module 114, and may be divided based on contents of the chat log analyzed via a NLP model. For example, the text portions may be determined based on parts of speech extracted from the chat log, or based on punctuation.

The method 400 may include, at block 420, processing the plurality of text portions to identify a first text portion that indicates a vulnerability action. The vulnerability action may be a request for action motivated (or clarified) indicated in the first text portion. For example, the vulnerability action may be a statement from the user that “I need to cancel this payment,” which may be indicated as a vulnerability action based on the terms “cancel” and “payment.”

The method 400 may include, at block 430, processing the plurality of text portions to identify a second text portion that indicates a vulnerability state. The vulnerability state may be a category or condition that qualifies the user as vulnerable, and may be indicated based on parts of speech of the words within each text portion. For example, a vulnerability state may be indicated by adjectives or nouns that characterize the user, such as “doctor” for ongoing health condition, or “lost my job” for negative life event. In some embodiments, the vulnerability state may be determined—similarly to the vulnerability action at block 420—using reference vectors.

The method 400 may include, at block 440, determining a type of the vulnerability action or of the vulnerability state. In some embodiments, the vulnerability action may be classified by comparing an embeddings vector representative of the relevant text portion from block 420 to a set of reference vectors that correspond to each of the possible vulnerability actions. In some embodiments, the vulnerability state may include low capability (e.g., lacking funds to complete transaction), low resilience (e.g., operating with low margins and at risk of being disrupted by an unexpected event), negative life event (e.g., in the midst of short-term circumstances that materially affect a user), or ongoing health condition (e.g., long-term circumstances that materially affect a user). In some embodiments, the vulnerability state may be determined based on an analysis of the term(s) from block 430 that initially indicated the presence of a vulnerability state.

The method 400 may include, at block 450, autonomously executing a remedial action based on the determined type from block 440. As described above with reference to the remedial module 118, the appropriate remedial action may be determined based on a matching list of classified vulnerability actions and/or states with corresponding actions.

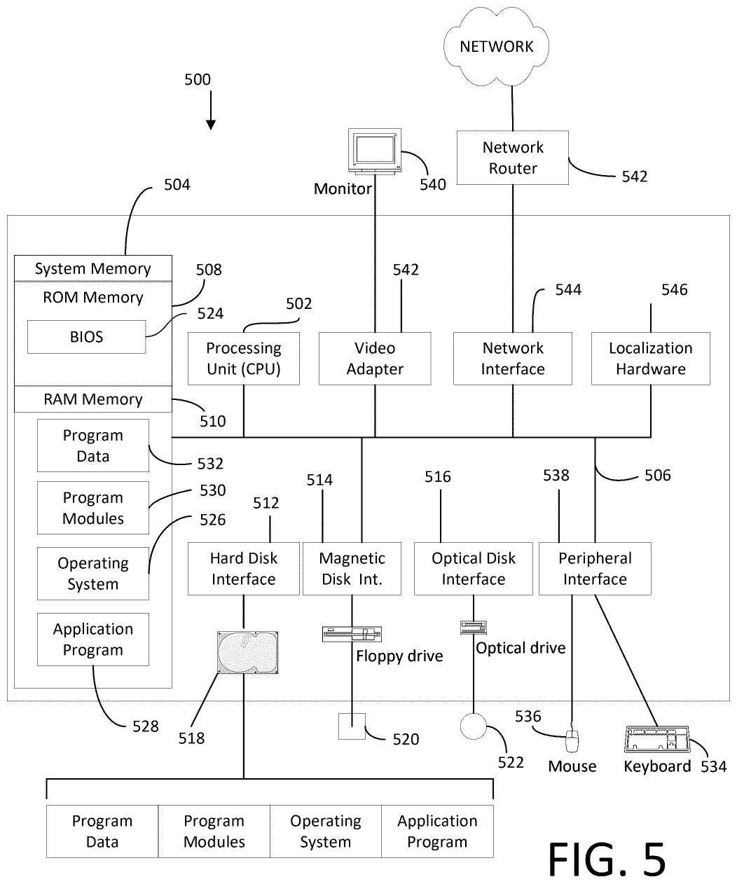

FIG. 5 is a diagrammatic view of an example embodiment of a user computing environment that includes a computing system environment 500, such as a desktop computer, laptop, smartphone, tablet, or any other such device having the ability to execute instructions, such as those stored within a non-transient, computer-readable medium. For example, the computing system environment 500 may be the service device 120 or a system hosting the vulnerability detection system 110. In another example, one or more components of the computing system environment 500, such as one or more CPUs 502, RAM memory 510, network interface 544, and one or more hard disks 518 or other storage devices, such as SSD or other FLASH storage, may be included in the vulnerability detection system 110. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 500 typically includes at least one processing unit 502 (e.g., processor 162) and at least one memory 504 (e.g., memory 164), which may be linked via a bus. Depending on the exact configuration and type of computing system environment, memory 504 may be volatile (such as RAM 510), non-volatile (such as ROM 508, flash memory, etc.) or some combination of the two. Computing system environment 500 may have additional features and/or functionality. For example, computing system environment 500 may also include additional storage (removable and/or non-removable) including, but not limited to, magnetic or optical disks, tape drives and/or flash drives. Such additional memory devices may be made accessible to the computing system environment 500 by means of, for example, a hard disk drive interface 512, a magnetic disk drive interface 514, and/or an optical disk drive interface 516. As will be understood, these devices, which would be linked to the system bus, respectively, allow for reading from and writing to a hard disk 518, reading from or writing to a removable magnetic disk 520, and/or for reading from or writing to a removable optical disk 522, such as a CD/DVD ROM or other optical media. The drive interfaces and their associated computer-readable media allow for the nonvolatile storage of computer readable instructions, data structures, program modules and other data for the computing system environment 500. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 500.

A number of program modules may be stored in one or more of the memory/media devices. For example, a basic input/output system (BIOS) 524, containing the basic routines that help to transfer information between elements within the computing system environment 500, such as during start-up, may be stored in ROM 508. Similarly, RAM 510, hard disk 518, and/or peripheral memory devices may be used to store computer executable instructions comprising an operating system 526, one or more applications programs 528 (which may include the functionality of the vulnerability detection system 110 of FIG. 1 or one or more of its functional modules 114, 116, and 118, for example), other program modules 530, and/or program data 532. Still further, computer-executable instructions may be downloaded to the computing environment 500 as needed, for example, via a network connection.

An end-user may enter commands and information into the computing system environment 500 through input devices such as a keyboard 534 and/or a pointing device 536. While not illustrated, other input devices may include a microphone, a joystick, a game pad, a scanner, etc. These and other input devices would typically be connected to the processing unit 502 by means of a peripheral interface 538 which, in turn, would be coupled to bus. Input devices may be directly or indirectly connected to processor 502 via interfaces such as, for example, a parallel port, game port, firewire, or a universal serial bus (USB). To view information from the computing system environment 500, a monitor 540 or other type of display device may also be connected to bus via an interface, such as via video adapter 542. In addition to the monitor 540, the computing system environment 500 may also include other peripheral output devices, not shown, such as speakers and printers.

The computing system environment 500 may also utilize logical connections to one or more computing system environments. Communications between the computing system environment 500 and the remote computing system environment may be exchanged via a further processing device, such a network router 542, that is responsible for network routing. Communications with the network router 542 may be performed via a network interface component 544. Thus, within such a networked environment, e.g., the Internet, World Wide Web, LAN, or other like type of wired or wireless network, it will be appreciated that program modules depicted relative to the computing system environment 500, or portions thereof, may be stored in the memory storage device(s) of the computing system environment 500.

The computing system environment 500 may also include localization hardware 546 for determining a location of the computing system environment 500. In embodiments, the localization hardware 546 may include, for example only, a GPS antenna, an RFID chip or reader, a WiFi antenna, or other computing hardware that may be used to capture or transmit signals that may be used to determine the location of the computing system environment 500.

In some embodiments, a system may include a processor; and a non-transitory computer readable medium stored thereon instructions that are executable by the processor to cause the system to perform operations may include receive a conversation log between a first user and a second user; derive, via a first machine learning model, at least one text chunk from the conversation log; process, via a second machine learning model, the at least one text chunk, the second machine learning model trained using previous conversation logs to determine whether the at least one text chunk indicates a vulnerability; in response to the at least one text chunk indicating the vulnerability, classify a type of the indicated vulnerability; and automatically execute a remedial action based on the classified type.

In some of these embodiments, deriving the at least one text chunk from the conversation log may include divide the conversation log into initial chunks; process each of the initial chunks to identify at least one part of speech; and determine one or more of the initial chunks as text chunks based on the identified parts of speech.

In some of these embodiments, determining whether the at least one text chunk indicates the vulnerability may include generate, by the second machine learning model, a vulnerability score for each of the at least one text chunk; and label each at least one text chunk as indicating the vulnerability in response to a respective vulnerability score being greater than a threshold value.

In some of these embodiments, generating the vulnerability score may include convert each of the at least one text chunk into a corresponding embeddings vector; and compute the vulnerability score for each text chunk based on the corresponding vector.

In some of these embodiments, the classifying the type of the indicated vulnerability may include retrieve a set of reference text chunks that correspond to a set of vulnerability types, wherein each of the set of reference text chunks represent one of the set of vulnerability types; compare the at least one text chunk indicative of the vulnerability to the set of reference text chunks; and determine the type of the indicated vulnerability based on the reference text chunk most similar to the at least one text chunk.

In some of these embodiments, training the second machine learning model may include retrieving a plurality of previous conversation logs; labelling each of the plurality of previous conversation logs based on whether the conversation log indicates a vulnerability; and generating a set of training data comprising the plurality of previous conversation logs and the respective labels.

In some of these embodiments, the instructions are further configured to cause the system to perform operations may include prior to deriving the at least one text chunk, pre-processing the conversation log to remove noise.

In some of these embodiments, a method may include dividing a chat log into a plurality of text portions; processing, by a first machine learning model, the plurality of text portions to identify a first text portion of the plurality of text portions that indicates a vulnerability action; processing, by a second machine learning model, the plurality of text portions to identify a second text portion of the plurality of text portions that indicate a vulnerability state; determine a type of the vulnerability action indicated by the first text portion or of the vulnerability state indicated by the second text portion; and autonomously execute a remedial action based on the determined type.

In some of these embodiments, identifying the first text portion may include converting the plurality of text portions into a corresponding plurality of embeddings vectors; determining a vulnerability score for each of the plurality of text portions based on a distance between each of the corresponding plurality of embeddings vectors and a reference vector representative of the vulnerability action; and determining the first text portion as the plurality of text portions having a respective vulnerability score above a threshold.

In some of these embodiments, the type of the vulnerability action comprises a plurality of action types, the reference vector comprises a plurality of reference vectors, each of the plurality of reference vectors being representative of one of the plurality of action types, and determining the type of the vulnerability action indicated by the first text portion further may include establishing the type of the vulnerability action as the action type represented by the reference vector closest to the embeddings vector corresponding to the first text portion.

In some of these embodiments, identifying the second text portion may include converting the plurality of text portions into a corresponding plurality of embeddings vectors; determining a vulnerability score for each of the plurality of text portions based on a distance between each of the corresponding plurality of embeddings vectors and a reference vector representative of the vulnerability state; and determining the second text portion as the plurality of text portions having a respective vulnerability score above a threshold.

In some of these embodiments, the type of the vulnerability state comprises a plurality of state types, the reference vector comprises a plurality of reference vectors, each of the plurality of reference vectors being representative of one of the plurality of state types, and determining the type of the vulnerability action indicated by the second text portion further may include establishing the type of the vulnerability state as the state type represented by the reference vector closest to the embeddings vector corresponding to the second text portion.

In some of these embodiments, the method may further include generating, by the first machine learning model, a first confidence score for the first text portion; and generating, by the second machine learning model, a second confidence score for the second text portion, wherein the autonomous execution of the remedial action is in response to the first confidence score and the second confidence score exceeding a threshold value.

In some embodiments, a method may include receiving an unstructured text file; converting the unstructured text file into a standardized format file; processing the standardized format file to remove noise; extracting a plurality of text features from the processed file; determining, by a machine learning model, a text feature indicative of a vulnerable feature, the machine learning model taking, as input, the plurality of text features and generating, as output, a likelihood that each of the plurality of text features includes the vulnerable feature; generating a notification comprising an indication of the determined text feature and a recommended action based on the indicated vulnerable feature; and executing the recommended action.

In some of these embodiments, the method may include determining a type of the indicated vulnerable feature, wherein the recommended action corresponds to the determined type.

In some of these embodiments, the determining the type of the indicated vulnerable feature may include retrieving a set of reference text features that correspond to a set of vulnerability types, wherein each of the set of reference text features represent one of the set of vulnerability types; comparing the text feature indicative of the vulnerability to the set of reference text features; and determining the type of the indicated vulnerable feature based on a reference text feature of the set of reference text features most similar to the at least one text feature.

In some of these embodiments, the method may further include generating a confidence score indicative of the output likelihood from the machine learning model, wherein the execution of the recommended action is in response to the confidence score exceeding a threshold value.

In some of these embodiments, the extraction of the plurality of text features may include dividing the processed file into a plurality of text chunks; and generating a plurality of embeddings vectors representative of the plurality of text chunks, wherein the plurality of text features comprises the generated plurality of embeddings vectors.

In some of these embodiments, the determination that the text feature is indicative of the vulnerable feature may include retrieving a reference embeddings vector representative of a reference text feature, the reference text feature indicative of the vulnerable feature; determining a distance between each of the generated plurality of embeddings vectors; and determining the text feature indicative of the vulnerable feature as the text feature corresponding to a closest one of the generated plurality of embeddings vectors to the reference embeddings vector.

In some of these embodiments, the unstructured text file comprises a transcript of an online chat.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A system comprising:
a processor; and
a non-transitory computer readable medium stored thereon instructions that are executable by the processor to cause the system to perform operations comprising:
receive a conversation log between a first user and a second user;
derive, via a first machine learning model, at least one text chunk from the conversation log;
process, via a second machine learning model, the at least one text chunk, the second machine learning model trained using previous conversation logs to determine whether the at least one text chunk indicates a vulnerability;
in response to the at least one text chunk indicating the vulnerability, classify a type of the indicated vulnerability; and
automatically execute a remedial action based on the classified type.

2. The system of claim 1, wherein deriving the at least one text chunk from the conversation log comprises:
divide the conversation log into initial chunks;
process each of the initial chunks to identify at least one part of speech; and
determine one or more of the initial chunks as text chunks based on the identified parts of speech.

3. The system of claim 1, wherein determining whether the at least one text chunk indicates the vulnerability comprises:
generate, by the second machine learning model, a vulnerability score for each of the at least one text chunk; and
label each at least one text chunk as indicating the vulnerability in response to a respective vulnerability score being greater than a threshold value.

4. The system of claim 3, wherein generating the vulnerability score comprises:
convert each of the at least one text chunk into a corresponding embeddings vector; and
compute the vulnerability score for each text chunk based on the corresponding vector.

5. The system of claim 1, wherein the classifying the type of the indicated vulnerability comprises:
retrieve a set of reference text chunks that correspond to a set of vulnerability types, wherein each of the set of reference text chunks represent one of the set of vulnerability types;
compare the at least one text chunk indicative of the vulnerability to the set of reference text chunks; and
determine the type of the indicated vulnerability based on the reference text chunk most similar to the at least one text chunk.

6. The system of claim 1, wherein training the second machine learning model comprises:
retrieving a plurality of previous conversation logs;
labelling each of the plurality of previous conversation logs based on whether the conversation log indicates a vulnerability; and
generating a set of training data comprising the plurality of previous conversation logs and the respective labels.

7. The system of claim 1, wherein the instructions are further configured to cause the system to perform operations comprising:
prior to deriving the at least one text chunk, pre-processing the conversation log to remove noise.

8. A method comprising:
dividing a chat log into a plurality of text portions;
processing, by a first machine learning model, the plurality of text portions to identify a first text portion of the plurality of text portions that indicates a vulnerability action;
processing, by a second machine learning model, the plurality of text portions to identify a second text portion of the plurality of text portions that indicate a vulnerability state;
determine a type of the vulnerability action indicated by the first text portion or of the vulnerability state indicated by the second text portion; and
autonomously execute a remedial action based on the determined type.

9. The method of claim 8, wherein identifying the first text portion comprises:
converting the plurality of text portions into a corresponding plurality of embeddings vectors;
determining a vulnerability score for each of the plurality of text portions based on a distance between each of the corresponding plurality of embeddings vectors and a reference vector representative of the vulnerability action; and
determining the first text portion as the plurality of text portions having a respective vulnerability score above a threshold.

10. The method of claim 9, wherein:
the type of the vulnerability action comprises a plurality of action types,
the reference vector comprises a plurality of reference vectors, each of the plurality of reference vectors being representative of one of the plurality of action types, and
determining the type of the vulnerability action indicated by the first text portion further comprises:
establishing the type of the vulnerability action as the action type represented by the reference vector closest to the embeddings vector corresponding to the first text portion.

11. The method of claim 8, wherein identifying the second text portion comprises:
converting the plurality of text portions into a corresponding plurality of embeddings vectors;
determining a vulnerability score for each of the plurality of text portions based on a distance between each of the corresponding plurality of embeddings vectors and a reference vector representative of the vulnerability state; and
determining the second text portion as the plurality of text portions having a respective vulnerability score above a threshold.

12. The method of claim 11, wherein:
the type of the vulnerability state comprises a plurality of state types,
the reference vector comprises a plurality of reference vectors, each of the plurality of reference vectors being representative of one of the plurality of state types, and
determining the type of the vulnerability action indicated by the second text portion further comprises:
establishing the type of the vulnerability state as the state type represented by the reference vector closest to the embeddings vector corresponding to the second text portion.

13. The method of claim 8, further comprising:
generating, by the first machine learning model, a first confidence score for the first text portion; and
generating, by the second machine learning model, a second confidence score for the second text portion,
wherein the autonomous execution of the remedial action is in response to the first confidence score and the second confidence score exceeding a threshold value.

14. A method comprising:
receiving an unstructured text file;
converting the unstructured text file into a standardized format file;
processing the standardized format file to remove noise;
extracting a plurality of text features from the processed file;
determining, by a machine learning model, a text feature indicative of a vulnerable feature, the machine learning model taking, as input, the plurality of text features and generating, as output, a likelihood that each of the plurality of text features includes the vulnerable feature;
generating a notification comprising an indication of the determined text feature and a recommended action based on the indicated vulnerable feature; and
executing the recommended action.

15. The method of claim 14, further comprising determining a type of the indicated vulnerable feature, wherein the recommended action corresponds to the determined type.

16. The method of claim 15, wherein the determining the type of the indicated vulnerable feature comprises:
retrieving a set of reference text features that correspond to a set of vulnerability types, wherein each of the set of reference text features represent one of the set of vulnerability types;
comparing the text feature indicative of the vulnerability to the set of reference text features; and
determining the type of the indicated vulnerable feature based on a reference text feature of the set of reference text features most similar to the at least one text feature.

17. The method of claim 14, further comprising generating a confidence score indicative of the output likelihood from the machine learning model, wherein the execution of the recommended action is in response to the confidence score exceeding a threshold value.

18. The method of claim 14, wherein the extraction of the plurality of text features comprises:
dividing the processed file into a plurality of text chunks; and
generating a plurality of embeddings vectors representative of the plurality of text chunks,
wherein the plurality of text features comprises the generated plurality of embeddings vectors.

19. The method of claim 18, wherein the determination that the text feature is indicative of the vulnerable feature comprises:
retrieving a reference embeddings vector representative of a reference text feature, the reference text feature indicative of the vulnerable feature;
determining a distance between each of the generated plurality of embeddings vectors; and
determining the text feature indicative of the vulnerable feature as the text feature corresponding to a closest one of the generated plurality of embeddings vectors to the reference embeddings vector.

20. The method of claim 14, wherein the unstructured text file comprises a transcript of an online chat.
